(19) United States
(12) Patent Application Publication
(10) Pub. No.: US 2005/0153736 A1
(43) Pub. Date: Jul. 14, 2005

(54) Method and apparatus for associating with a communication system

(76) Inventor: Robert B. Ganton, San Diego, CA (US)

Correspondence Address: MOTOROLA INC, 600 NORTH US HIGHWAY 45, ROOM AS437, LIBERTYVILLE, IL, 60048-5343, US

(21) Appl. No.: 11/022,543

(22) Filed: Dec. 22, 2004

Related U.S. Application Data
(60) Provisional application No. 60/534,300, filed on Jan. 5, 2004.

(51) Int. Cl. H04Q 7/24; H04M 1/00; H04Q 7/20

(52) U.S. Cl. 455/553.1; 455/552.1; 455/426.1

(57) ABSTRACT

A method in a wireless device (100) for communicating with a WLAN access point (112) and a wide area network is disclosed. The first step (302) includes scanning a first set of channels in a first radio frequency band for at least one pilot channel signal. In the next step (304) the device 100 receives a pilot channel signal on the first radio frequency band, the signal having a unique identification. The device, in response to receiving the pilot channel signal with the unique identification then turns on (306) a receiver that receives signals in a second radio frequency band. The device then searches, in step (308) for a signal, on the second radio frequency band, for a WLAN access point. The device then determines if a WLAN access point signal has been received, in step (310). The device associates with the WLAN, in step (312) if the device receives the WLAN access point signal. The device, in step (314), turns off the receiver if a WLAN access point signal has not been received.

This application is a continuation of Application No. 60/534,300, filed 5 Jan. 2004.

### FIELD OF THE INVENTION

The present invention pertains to wireless local area networks, and more particularly to the detection of a wireless local area network.

### BACKGROUND OF THE INVENTION

As demand for access to the internet increases, the number of access points to the internet also continues to grow in both the wired and wireless form. Wireless local area network (WLAN) access points such IEEE 802.11, Bluetooth and Home RF are generally known. WLAN access points are proliferating in both the home and in the commercial environment. Devices that typically access the internet through WLAN access points are laptop computers, handheld or palm top computers, PDA's, desktop computers and the like. The geographical coverage area of a WLAN is generally known as a hot spot. Hot spots are generally independent but may overlap as more WLAN access points are deployed. Even though the RF footprint of a WLAN is much smaller than a radiotelephone network cell, a WLAN coverage area and a radiotelephone cell coverage area overlap, wireless devices can not access both networks or roam between the two.

A radiotelephone network operates under one set of standard protocols while WLANS operate under another. Both systems operate in separate independent frequency bands which are specifically assigned to the type of network. Mobile stations that utilize the radiotelephone system generally access multiple cells or base stations as the mobile station moves about geographically. The mobile station is handed off from one cell to another to accommodate the best RF signal reception.

Devices are being developed to access both the WLAN and radiotelephone networks. This will require the device to scan both frequency bands in order to determine which networks are available. Scanning both frequency bands requires a significant amount of power resulting in an undesirable level of current drain and decreased operational time of the device between battery charges.

Accordingly it is desired to have a wireless device that can access both a WLAN and a radiotelephone network with improved current drain.

For a variety of reasons, it is envisioned that users will want to readily move into areas where there is radio coverage by a radiotelephone base station and a wireless access point. To ensure the best coverage, the wireless device may have the capability to communicate with both the cellular radiotelephone system and the wireless internet access point.

### BRIEF DESCRIPTION OF THE DRAWINGS

The accompanying figures, where like reference numerals refer to identical or functionally similar elements throughout the separate views, serve to illustrate various embodiments and to explain various principles and advantages of the present invention.

FIG. 1 is an exemplary communications system in accordance with the present invention.

FIG. 2 is an exemplary block diagram of one or more mobile devices of FIG. 1.

FIG. 3 is an exemplary flow diagram for a method of communicating in the mobile device.

FIG. 4 is an exemplary flow diagram for a method of communicating in the mobile device.

FIG. 5 is an exemplary flow diagram for a method of communicating in the mobile device.

### DETAILED DESCRIPTION OF THE INVENTION

While the present invention is achievable by various forms of embodiment, there is shown in the drawings and described hereinafter, present exemplary embodiments with the understanding that the present disclosure is to be considered an exemplification of the invention and is not intended to limit the invention to the specific embodiments contained herein.

As the availability to the internet through wireless local area network (WLAN) access points increases, the number of the WLAN access point and the corresponding coverage areas associated therewith will concurrently expand. The WLAN access points provide access in general to computers, by providing a flexible, wireless network. These systems generally have small coverage areas and operate on low power, providing access to office buildings, homes, airports and the like. Cellular radiotelephones systems which provide communication access to remote or mobile wireless stations, provide larger coverage areas which also continue to grow but still only in certain areas. Cellular systems do not propagate well into buildings and therefore provide poor indoor coverage in general. A method is herein disclosed that provides for a cellular system to co-operate with WLAN access point to provide improved coverage. The method in a wireless communication device, such as a mobile station, for handoffs between a wireless local area network and wide area network, such as a cellular system, is disclosed.

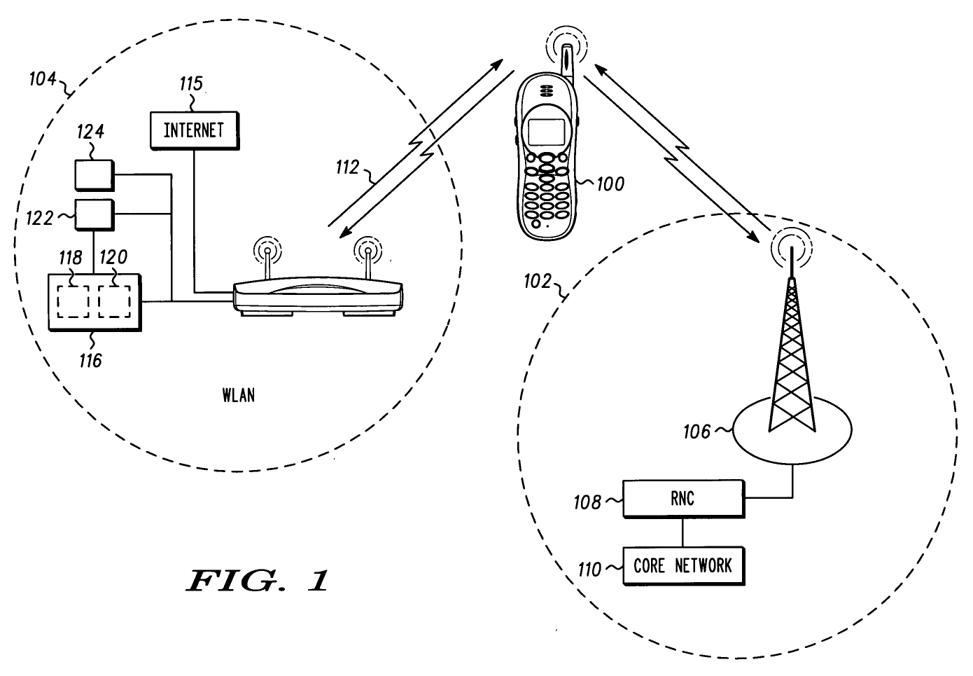

In FIG. 1, a wireless communication device 100 that operates with a cellular radiotelephone system 102 and with at least one WLAN access point 104 is shown. The wireless communication device 100 supports a wireless communication link with another device, a base station, a satellite, or the like. The wireless communication device 100, may be, but is not limited to, a mobile station, radio equipment, or a mobile unit, and may for example be a cellular radiotelephone, a telematics in-vehicle system, or a personal computer, pager, personal digital assistant, or handheld computer including an internal or coupled wireless communication circuitry.

The cellular radiotelephone system 102 includes a base station 106, a radio network controller (RNC) 108 which comprise the radiotelephone access network (RAN). The RNC 108 couples the RAN, in this exemplary embodiment, to at least one core network 110. The RAN may be comprised of one or multiple base stations, such as the exemplary base station 106.

The base station 106 may be a radiotelephone base station, such as a wide area network cellular system, a general broadcast transmitter such as TV or radio transmitters and the like. The base station 106 may operate in one or more of a plurality of communication modes such a code division multiple access (CDMA), wideband code division multiple access (WCDMA), global system for mobile communication (GSM), time division multiple access (TDMA) or the like.

The WLAN access point may be an 802.11 wireless access point, also known as WiFi that provides wireless access to the internet. Although most WLAN access points are fixed they may also be mobile or temporary or both. The WLAN may operate in the unlicensed industrial scientific and medical (ISM) radio frequency band or the like or licensed radio frequency bands for example.

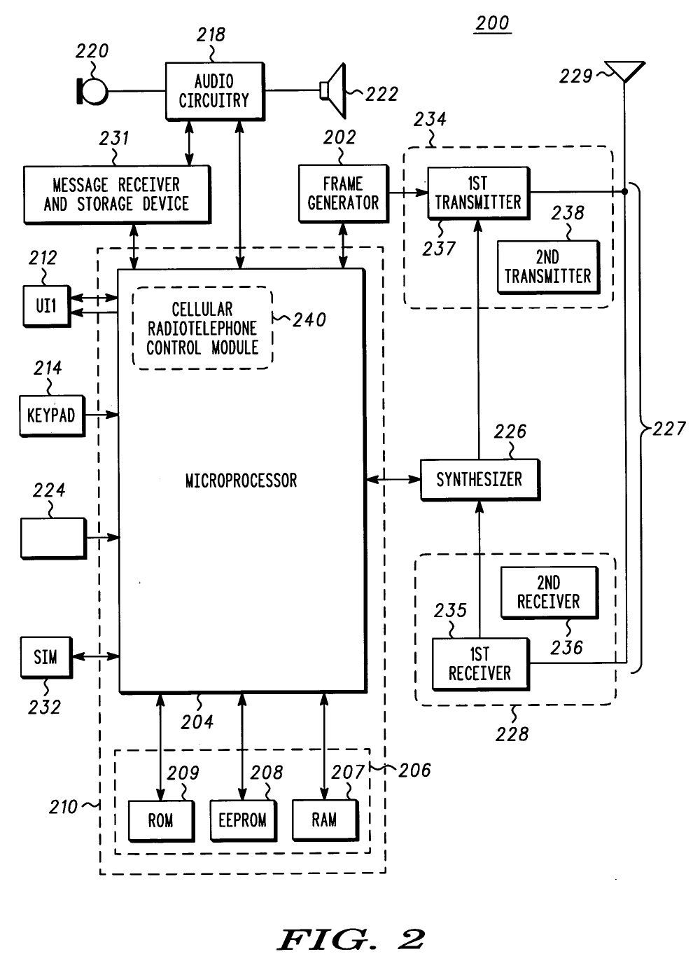

Turning to FIG. 2, a block diagram of a wireless communication device 200 in accordance with one exemplary embodiment of the invention is shown. The exemplary embodiment is a cellular radiotelephone incorporating the present invention. However, it is to be understood that the present invention is not limited to the preferred embodiment and may be utilized by other wireless communication devices such as paging devices, personal digital assistants, portable computing devices, and the like, having wireless communication capabilities. In the exemplary embodiment a frame generator Application Specific Integrated Circuit (ASIC) 202, such as a CMOS ASIC or the like, and a microprocessor 204, combine to generate the necessary communication protocol for operating in a cellular radiotelephone system. Microprocessor 204 uses memory 206 comprising RAM 207, EEPROM 208, and ROM 209, preferably consolidated in one package 210, to execute the steps necessary to generate the protocol and to perform other functions for the wireless communication device, such as writing to a display 212, accepting information from a keypad 114, or controlling a frequency synthesizer 226. The memory may also include a SIM card 232. ASIC 202 processes audio transformed by audio circuitry 218 from a microphone 220 and to a speaker 222.

FIG. 2 also shows the transceiver 227 comprising a receiver 228 that is capable of receiving radio frequency (RF) signals from at least two RF bands and optionally more bands, as is required for operation of a multiple mode communication device. The receiver 228 may comprise a first receiver 235 and a second receiver 236, or one receiver capable of receiving in two or more RF bands. The receiver depending on the mode of operation may be attuned to receive AMPS, GSM, CDMA, UMTS, WCDMA, Bluetooth, WLAN, such as 802.11 communication signals for example. The transmitter 234, is capable of transmitting RF signals in at least two RF bands in accordance with the operation modes described above. The transmitter 234 may also include a first transmitter 237 and second transmitter 238 to transmit on the at least two RF bands or one transmitter that is capable of transmitting on at least two bands. In the exemplary embodiment, the first band or set of bands is for communication with a communication system such as a cellular radiotelephone service. The second band or set of bands is for communication between a wireless device and a WLAN.

The wireless communication device 200 may also include a cellular radiotelephone control module 240 and a wireless local area network control module 242 which may be included as part of the microprocessor (FIG. 1) 204 or as separate modules which are coupled to the microprocessor 204. The cellular radiotelephone control module 240 and the wireless local area network control module 242 may also be stored in memory 206 or in a SIM card 232 or other plug-in or external module that couples to the wireless communication device 200. The cellular radiotelephone control module 240 may reside in one of any of the above of the wireless communication device 200 and independent thereof, the wireless local area network control module 242, may also reside in one of any of the above of the wireless communication device 200. For example, the cellular radiotelephone control module 240 may reside in the microprocessor 204, while the wireless local area network control module 242 may reside in the memory 206 of the wireless communication device 200. It is envisioned that in one exemplary embodiment, the one of the cellular radiotelephone control module 240 or the wireless local area network control module 242 reside on a plug-in module, such as a SIM card 232 or a compact flash, SmartMedia, Secure Digital, memory stick, micro drive memory device or the like.

The WLAN access point 104 includes a transceiver that further includes a transmitter 116, a receiver 122 and a processor 124. The WLAN access point 104 may be coupled to the internet 115 or another type of network. The transmitter 116 is capable of transmitting in the ISM band and in the cellular radiotelephone system 102 band. The transmitter 116 may be comprised of two transmitters, a first transmitter 118 to transmit in the cellular radiotelephone system 102 band and a second transmitter 120 to transmit in the ISM band. The transmitter 116 may also be capable of tuning to both the ISM band and in the cellular radiotelephone system 102 band as a single transmitter.

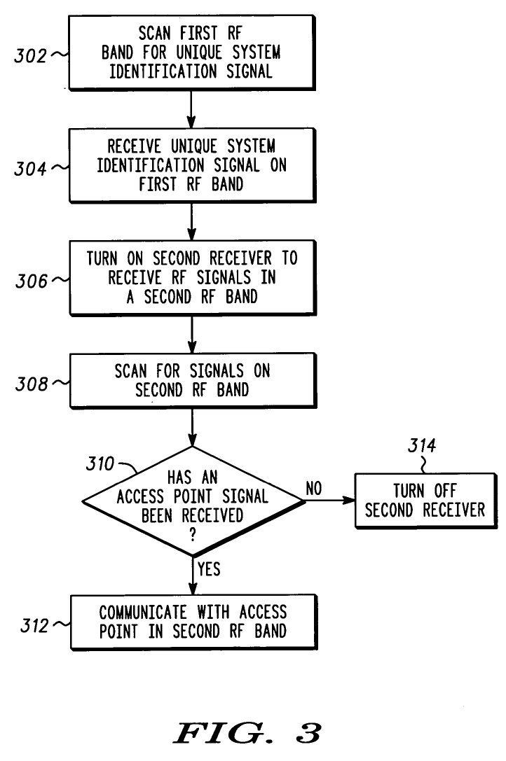

Moving to FIG. 3, the method in a wireless communication device (device) 100 of communicating with a WLAN access point in one exemplary embodiment is shown. The first step 302 includes scanning in a first radio frequency band, which is the cellular radiotelephone frequency band in this exemplary embodiment, for at least one unique system identification signal. In the next step, 304, the device 100 receives a unique system identification signal on the first radio frequency (RF) band. The unique system identification signal is characterized in this embodiment by a time offset relative to at least one other system identification signal also transmitted in the first RF band. In response to receiving the unique system identification signal, the device 100, in step 306, turns on the second receiver 236, or tunes the first receiver 235, to receive signals in a second radio frequency (RF) band. The device 100 then searches, in step 308 for a signal, on the second RF band. The device 100 then determines if an access point signal 112 has been received, in step 310. The device 100 communicates with the access point 104, in step 312 if the device 100 receives the access point signal 112. The device, in step 314, turns off the receiver if the access point signal 112 has not been received.

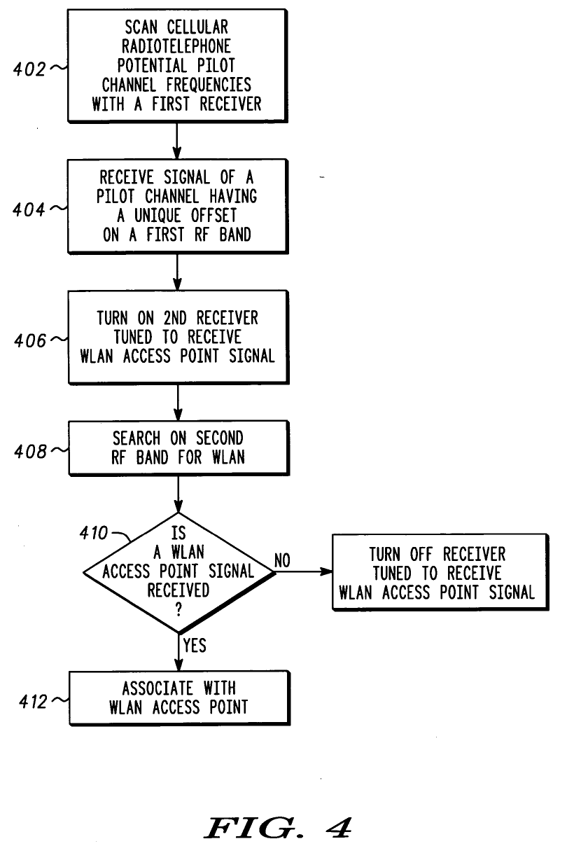

In one exemplary embodiment, illustrated in FIG. 4, shows a method for a wireless communication device 100 that operates with a cellular radiotelephone system 102 and with at least one WLAN access point 104. The first step 402 includes scanning in a first radio frequency band, which is the cellular radiotelephone frequency band in this exemplary embodiment, for at least one unique system identification signal. The unique identification signal in this exemplary embodiment is referred to as a pilot channel. The pilot channel is broadcast from the base station 106 and identifies the particular base station to the device 100. Other base stations of the cellular communication system 102 similarly broadcast pilot channels each identifying the particular base station to the mobile devices of the system. The device 100 determines which base station to communicate with based on information or signal strength of the particular pilot channel.

The device 100 may scan for a pilot channel in a first set of channels in the first RF band. The first set of channels may be a predetermined set of channels stored in the device 100 or a set of channels received by the device 100 from the network or base station 104. The pilot channel may be a logical channel, such as a time slot within a given frame on a particular frequency for example in a time division multiple access channel system. The pilot channel may also be a logical channel defined by a code such as a pseudorandom noise (PN) code in a code division multiple access system (CDMA). In the CDMA system, each pilot channel is defined time offset in reference to other pilot channels in the cellular radiotelephone system 102. The device 100 in this embodiment receives, in step 404 the unique pilot channel with a time offset, unknown to the device 100 which is broadcast in the first RF band.

In response to receiving the unique pilot channel, the device 100, turns on a second receiver 236, in step 406 tuned to receive signals from a WLAN access point. The device 100 searches, in step 408, in the ISM band in the exemplary embodiment, for the WLAN access point signal 112. When the device 100 receives the WLAN access point signal 112, in step 410, the device 100 then associates with the WLAN access point signal 112, in step 412. The device 100 may then commence communication with the WLAN access point 104. If the device 100 does not receive a WLAN access point signal 112 in step 410, the second receiver 236 is turned off. This reduces current drain by the device 100 and conserves power in the device 100 which may be powered by batteries.

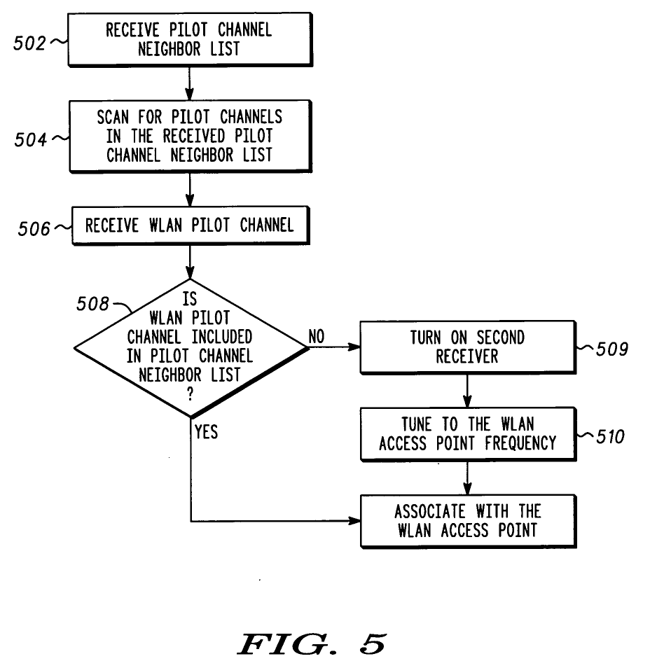

In another exemplary embodiment, illustrated in FIG. 5, the device receives from the base station 106 and stores in memory 206 a pilot channel neighbor list. The pilot channel neighbor list contains information of the pilot channels of each neighboring base station of the base station 106 of the cellular radiotelephone system 102. The device 100 receives the pilot channel neighbor list from the current base station 106 that the device 100 is in communication with in step 502. The device 100, in step 504, scans for or receives the pilot channels identified in the pilot channel neighbor list previously received in step 502. The WLAN pilot channel in this embodiment, is not included in the pilot channel neighbor list. In step 506, the receiver 228 in the device 100 scans for pilot channels, and receives the WLAN pilot channel that is broadcast by the WLAN access point 112 in the same band as the cellular radiotelephone system 102 pilot channels. The device 100, in step 508, determines that the WLAN pilot channel is not in the pilot channel neighbor list and is not apart of the cellular radiotelephone system 102. The device 100, in step 509 turns on the second receiver 236 and tunes, in step 510 to the WLAN access point 104 frequency. The device 100 associates, in step 512, with the WLAN access point 104. Communications between the WLAN access point 104 and the device 100 may then commence. In another embodiment, the WLAN pilot channel information is included in the pilot channel neighbor list.

In one exemplary embodiment, an exemplary CDMA system the base station 106 provides the neighbor list to the device 100. An extended neighbor list is also provided. In the extended neighbor list the presence of a WLAN access point is indicated. In this embodiment, the NGHBR_CONFIG field is set to between 100 and 111. Then the NGHBR_PN is set to the offset corresponding to the CDMA pilot beacon. This is 9 bits in length. Then the NGHBR_FREQ is set to indicate the WLAN access point channel assignment of WLAN access point or network that is within the geographical are of the base station 106. Finally, the NGHBR_BAND is set to indicate 2.4 GHz or 5.8 GHz radio frequency band of the WLAN access point 112.

In yet another embodiment, WLAN access point 112 transmits, in a cellular radiotelephone system radio frequency band, a WLAN pilot channel, or beacon, which is a pilot channel having the same structure as the cellular radiotelephone system 102 pilot channel. The WLAN pilot channel signal has a unique time offset that is unique from the pilot channels of the cellular radiotelephone system 102. In one embodiment, the WLAN pilot channel is not in a pilot channel list of the device 100 the base station 106. To communicate with the device 100, the WLAN access point 112 also transmits and receives signals that are in the WLAN access point radio frequency band, which may be in the ISM band for example in which systems operate within the 802.11 standard. The receiver 228 or the second receiver 236 in the device 100, is operable within the ISM band as well to communicate with the WLAN access point 112. The WLAN pilot channel information may also be included in the neighbor list as discussed above. The device 100 would then scan for the WLAN pilot channel as part of the candidate set, active set or remaining set of pilot channels in one embodiment. The WLAN pilot channel in one embodiment may be synchronized with the signals, the pilot channel signals in particular of the cellular radiotelephone system. For example, the WLAN pilot channel signal is synched with the GPS/CDMA timing in the CDMA system.

The device may be able to communicate over the cellular radiotelephone system 102 and the WLAN access point simultaneously. This may require a handoff between the cellular radiotelephone system 102 and the WLAN access point 104 or to communicate simultaneously over both systems. For example, when a device 100 is capable of communicating voice over the internet protocol (VoIP), and the device 100 moves into an area covered by a WLAN access point 112, a call initiated on a cellular radiotelephone system 102, and the device 100 decides that it should switch to the WLAN access point 112, for signal reception purposes for example. The device 100, in accordance with the above disclosed methods, switches or performs a handoff to the WLAN access point 112. Similarly the device 100 may want to handoff from the WLAN access point 112 to the cellular radiotelephone system 102. In another exemplary embodiment, the device 100 may be engaged in voice interchange activity with a cellular radiotelephone system 102 and the user may desire to exchange data with the internet. The device 100 may establish a link with the WLAN access point 112 simultaneously with the link with the cellular radiotelephone system 102. The voice interchange would be continued while data is downloaded or uploaded to the WLAN access point and displayed on the device 100.

Those skilled in the art will recognize that the WLAN access point 112 may transmit various types of system identification signals in accordance with a plurality of communication systems. The foregoing description is not intended to be exhaustive or to limit the invention to the precise form disclosed. Those skilled in the art will recognize that modifications or variations are possible in light of the above teachings, and all modifications and variations shall be deemed to be within the scope of the invention which is limited only by the claims.

1. A method in a wireless communication device comprising:
receiving a first system identification signal in a first radio frequency band, the first identification signal identifying a system operating in the first radio frequency band;
receiving a second system identification signal in the first band, the second system identification signal identifying a system operating in a second radio frequency band, different from the first radio frequency band.

2. A method in a wireless communication device comprising:
monitoring a plurality of pilot channels having known pilot channel offset, wherein the pilot channel offset identifies the source of the pilot channel;
determining that at least one pilot channel has an offset that is not known;
scanning a second set of frequencies, not associated with the plurality of pilot channels; and
establishing a connection with a WLAN.

3. A method in a wireless local area network access point comprising the steps of:
transmitting a pilot channel in a radiotelephone radio frequency band; and
transmitting communication signals in a wireless local area network band.

4. The method of claim 3, wherein the step of transmitting the pilot channel comprises transmitting a pseudorandom noise code on a radiotelephone frequency, wherein the pseudorandom noise code has a known offset from a second pseudorandom noise code transmitted by a radiotelephone system.
